(19) United States
(12) Patent Application Publication
(10) Pub. No.: US 2016/0238406 A1
(43) Pub. Date: Aug. 18, 2016

(54) REFRIGERATED TRANSPORT CONTAINER WIRELESS REMOTE TRACKING AND MANAGEMENT SYSTEMS AND METHODS

(71) Applicant: The Burtner Group, LLC, Reston, VA (US)

(72) Inventors: Richard Lee BURTNER, Broadlands, VA (US); Jason Michael GAFA, Bartlett, TN (US)

(21) Appl. No.: 15/045,239

(22) Filed: Feb. 16, 2016

Related U.S. Application Data
(60) Provisional application No. 62/116,358, filed on Feb. 13, 2015.
(60) Provisional application No. 62/116,356, filed on Feb. 13, 2015.

(51) Int. Cl. G01C 21/36; G06F 17/30; H04B 1/38; F25D 11/00; G01S 19/42

(52) U.S. Cl. CPC G01C 21/3667; F25D 11/003; G01S 19/42; H04B 1/38; G06F 17/30353; G06F 17/30312; F25D 2400/32

(57) ABSTRACT

Refrigerated transport container wireless remote tracking and management systems include one or more sensors installed on an asset, the sensors including a positioning sensor and a temperature sensor, and a remote central computing device configured to receive data from the sensors, process the data, associate it with a date/time of generation, and store the data, and including modules. The modules include a communications module, a display module displaying data overlaid on a map to indicate a position of the asset, an asset information module to receive asset information and associate it with the asset, a sensor reading anomaly module to receive sensor reading anomaly criteria and sensor readings and send a notification when the asset crosses a sensor reading threshold, a sensor reading anomaly criteria customization module to receive allowable sensor readings and to create sensor reading anomaly criteria, and a dashboard module configured to display a time-period data summary.

This application claims the benefit of U.S. Provisional Application Nos. 62/116,356 and 62/116,358, each filed Feb. 13, 2015, which are hereby incorporated by reference in their entireties.

### BACKGROUND

The application relates generally to remote asset monitoring, and particularly to wireless tracking and sensor monitoring of refrigerated products, and management thereof.

Existing refrigerated asset monitoring solutions do not ensure timely and reliable notification of all relevant parties.

Needs exist for improved refrigerated asset tracking systems and methods.

### SUMMARY

It is to be understood that both the following summary and the detailed description are exemplary and explanatory and are intended to provide further explanation of the invention as claimed. Neither the summary nor the description that follows is intended to define or limit the scope of the invention to the particular features mentioned in the summary or in the description.

In certain embodiments, the disclosed embodiments may include one or more of the features described herein.

A new system includes one or more sensors installed on an asset to be tracked, the sensors including a positioning sensor and a second sensor, and a remote central computing device configured to receive data from the sensors, process the data, associate it with a date/time of generation, and store the data in a database and including modules. The modules may include a communications module configured to receive requests for data from remote user computing devices and to transmit requested data to the remote user computing devices, a display module configured to display the requested data on the remote user computing device, including displaying data from the positioning sensor overlaid on a map to indicate a position of the asset, an asset information module configured to receive asset information from the remote user computing device and associate it with the asset, a sensor reading anomaly module configured to receive sensor reading anomaly criteria from the sensor reading anomaly criteria customization module and sensor readings from the second sensor and send a notification when the sensor readings indicate that the asset crosses a sensor reading threshold, a sensor reading anomaly criteria customization module configured to receive information relating to allowable sensor readings from the remote user computing devices and to create sensor reading anomaly criteria comprising sensor reading limits and to transmit them to the sensor anomaly module, and a dashboard module configured to display a time-period data summary on the remote user computing device detailing information associated with the asset position over a set period of time and to display a route summary on the remote user computing device detailing compliance with the sensor reading thresholds over the time period.

The asset information may include graphics for display on the map as part displaying the data from the positioning sensor. The second sensor may be a temperature sensor.

The sensor reading anomaly criteria may include multiple tiered thresholds, where crossing a lower tier threshold triggers anomaly logging, crossing a higher tier threshold triggers notifications to one or more recipients, and crossing a highest tier threshold triggers notifications to multiple recipients and instructions for one or more of the recipients to take predetermined actions. The second sensor may be a temperature sensor, the lower tier threshold may include a first temperature reading, the higher tier threshold may include a second temperature reading higher than the first temperature reading, and the highest tier threshold may include a third temperature reading higher than the second temperature reading, where the instructions include instructions for a driver to inspect and/or discard goods being shipped on the asset. At least one of the multiple tiered thresholds may also include a time duration, such that the threshold is not considered to have been crossed unless an associated temperature reading is exceeded for at least the time duration. The received sensor reading anomaly criteria may be functions of a type of the asset to be tracked and/or a type of load to be transported on the asset. The one or more sensors may include additional temperature sensors, where the temperature sensor and additional temperature sensors are installed at different locations on the asset and the installation locations are recorded, where one or more locations where temperature-sensitive goods are located on the asset are recorded, at least one of which is not an installation location for one of the temperature sensors, where the thresholds relate to determined temperature at the locations of the temperature-sensitive goods, where the sensor reading anomaly module is further configured to interpolate temperature readings at the locations of the temperature-sensitive goods based on sensor readings from the temperature sensors and the recorded locations of the temperature sensors and the temperature-sensitive goods.

The sensor reading anomaly module may be further configured to determine a cause of sensor reading anomalies by determining whether various factors are correlated with detected sensor reading anomalies, the various factors including environmental conditions at the position of the asset, persons controlling the asset, other sensor readings on the asset, asset type, and/or asset equipment type and/or status, when the detected sensor reading anomalies occurred.

The sensor reading anomaly criteria customization module may be further configured to record the information relating to allowable sensor readings as a template associated with an asset type and/or asset contents, and to automatically use the stored template to automatically create sensor reading anomaly criteria for other assets of the same asset type and/or having the same asset contents without further user input.

A new method may include installing one or more sensors on an asset to be tracked, the sensors including a positioning sensor and a second sensor, transmitting data wirelessly from the sensors to a remote central computing device, processing the data, associating it with a date/time of generation, and storing the data in a database, receiving a request for some of the data from a remote user computing device, transmitting the requested data to the remote user computing device, displaying the requested data on the remote user computing device, including displaying data from the positioning sensor overlaid on a map to indicate a position of the asset, receiving asset information from the remote user computing device and associating it with the asset, receiving sensor reading anomaly criteria and sending a notification when the data indicates that asset sensor readings cross a sensor reading threshold, receiving information relating to allowable sensor readings from the remote user computing device to create sensor reading anomaly criteria comprising sensor reading thresholds, displaying a time-period data summary on the remote user computing device detailing information associated with the asset location over a set period of time, and displaying a route summary on the remote user computing device detailing compliance with the sensor reading limits over the time period.

The asset information may include graphics for display on the map as part displaying the data from the positioning sensor.

The second sensor may be a temperature sensor.

The sensor reading anomaly criteria may include multiple tiered thresholds, where crossing a lower tier threshold triggers anomaly logging, crossing a higher tier threshold triggers notifications to one or more recipients, and crossing a highest tier threshold triggers notifications to multiple recipients and instructions for one or more of the recipients to take predetermined actions. The second sensor may be a temperature sensor, the lower tier threshold may include a first temperature reading, the higher tier threshold may include a second temperature reading higher than the first temperature reading, and the highest tier threshold may include a third temperature reading higher than the second temperature reading, where the instructions include instructions for a driver to inspect and/or discard goods being shipped on the asset. At least one of the multiple tiered thresholds may include a time duration, such that the threshold is not considered to have been crossed unless an associated temperature reading is exceeded for at least the time duration. The received sensor reading anomaly criteria may be functions of a type of the asset to be tracked and/or a type of load to be transported on the asset. The one or more sensors may include additional temperature sensors, where the temperature sensor and additional temperature sensors are installed at different locations on the asset and the installation locations are recorded, where one or more locations where temperature-sensitive goods are located on the asset are recorded, at least one of which is not an installation location for one of the temperature sensors, where the thresholds relate to determined temperature at the locations of the temperature-sensitive goods, the method further including interpolating temperature readings at the locations of the temperature-sensitive goods based on sensor readings from the temperature sensors and the recorded locations of the temperature sensors and the temperature-sensitive goods.

The method may include determining a cause of sensor reading anomalies by determining whether various factors are correlated with detected sensor reading anomalies, the various factors including environmental conditions at the position of the asset, persons controlling the asset, other sensor readings on the asset, asset type, and/or asset equipment type and/or status, when the detected sensor reading anomalies occurred.

The method may include recording the information relating to allowable sensor readings as a template associated with an asset type and/or asset contents, and automatically using the stored template to automatically create sensor reading anomaly criteria for other assets of the same asset type and/or having the same asset contents without further user input.

### BRIEF DESCRIPTION OF THE DRAWINGS

The accompanying drawings, which are incorporated herein and form a part of the specification, illustrate exemplary embodiments and, together with the description, further serve to enable a person skilled in the pertinent art to make and use these embodiments and others that will be apparent to those skilled in the art.

FIG. 1 is a diagram illustrating a backend architecture for a refrigerated asset tracking system, in an embodiment.

FIG. 2 is a screenshot illustrating a user login page for tracking software, in an embodiment. Log-in fields include company, user name, and password for a standard authentication process.

FIG. 3 is a screen shot illustrating icons on a map in an embodiment of a tracking software.

FIG. 4 is a screen shot containing information on all the vehicles or assets in a specific account, in an embodiment of a tracking software.

FIG. 5 is a screen shot showing a vehicle user and related driver information set up screen, in an embodiment of a tracking software.

FIG. 6 is a screen shot showing a “Locate now” icon, in an embodiment of a tracking software.

FIG. 7 is a screen shot of a Geo Fence capability, in an embodiment of a tracking software.

FIG. 8 is a screen shot showing a starter disable function, in an embodiment of a tracking software.

FIG. 9 is a screen shot showing a user-created designated route, which is followed by a vehicle or asset on a regular basis, in an embodiment of a tracking software.

FIG. 10 is a screen shot showing a route set-up page “Draw” that allows the user to create and edit routes, in an embodiment of a tracking software.

FIG. 11 is a screen shot showing a Fleet Dashboard with an exception reporting focus for paring back unnecessary data prompting and time wasting report reviews, in an embodiment of a tracking software.

FIG. 12 is a screen shot of a Route Utilization dashboard, in an embodiment of a tracking software.

FIG. 13 is a diagram illustrating a system configured to track and manage remote assets, and in particular refrigerated transport containers, in accordance with one or more implementations

FIG. 14 is a block diagram illustrating an exemplary computing environment 100, in accordance with an embodiment of the present invention.

FIG. 15 is a screen shot showing a Fleet Dashboard, in an embodiment of a tracking software.

FIG. 16 illustrates a temperature probe, in accordance with an embodiment of the present invention.

FIG. 17 illustrates a tracking device, in accordance with an embodiment of the present invention.

### DETAILED DESCRIPTION

A wireless asset tracking system and method will now be disclosed in terms of various exemplary embodiments. This specification discloses one or more embodiments that incorporate features of the invention. The embodiment(s) described, and references in the specification to “one embodiment”, “an embodiment”, “an example embodiment”, etc., indicate that the embodiment(s) described may include a particular feature, structure, or characteristic. Such phrases are not necessarily referring to the same embodiment. When a particular feature, structure, or characteristic is described in connection with an embodiment, persons skilled in the art may effect such feature, structure, or characteristic in connection with other embodiments whether or not explicitly described.

In the several figures, like reference numerals may be used for like elements having like functions even in different drawings. The figures are not to scale. The embodiments described, and their detailed construction and elements, are merely provided to assist in a comprehensive understanding of the invention. Thus, it is apparent that the present invention can be carried out in a variety of ways, and does not require any of the specific features described herein. Also, well-known functions or constructions are not described in detail since they would obscure the invention with unnecessary detail.

In some embodiments of the disclosed system, a wireless asset tracking solution comprises a suite of hardware devices and sensors mounted and installed on assets, such as an over the road refrigerated trailer or truck, that sends real time temperature data with GPS position information via a wireless network and/or satellite network, such as the GSM network used by AT&T and T-Mobile in the United States or the GlobalStar/other satellites network available on most continents and oceans, to a back-end platform and user-accessible tracking software GUI. The sensors are devices or hardware that detect or measure a physical property on a vehicle/asset. An asset may be any type of equipment of useful value or property owned by a person or company. Raw data is untranslated data from the hardware. The back-end platform software and dashboard allows the end user to better manage and report on an e.g. trailer and truck by accessing the web-site 24×7, via a smart phone mobile application or by receiving reports and alerts via email or text message on a personal cell phone. Data is linked bi-directionally from the hardware and sensors mounted on the trailer or truck to the back-end software and dashboard (in addition to receiving data from the hardware, instructions may also be sent to the hardware).

The information and data can be used to improve efficiencies in a business or provide current real time temperature readings to a central dispatch so that expensive, temperature sensitive, and perishable cargo loads do not spoil.

Benefits of the real-time temperature tracking system include fuel savings from monitoring and reducing reefer run times, real time insight and record keeping of the inside temperature of the trailer from pick up through drop off, instant notifications of arrival and departure times that improve customer service, reduction of unnecessary idle times, and improved trailer and truck utilization. Further, the back-end offers a flexible reporting platform with a full suite of reports, ranging from very detailed to high level, all generated in an easy-to-read format.

The back-end platform includes the gateway, database and APIs required to store, display and translate raw data from the hardware. APIs are application programming interfaces with a defined function and method for interfacing with underlying operating systems or other programs running on a computer device. A gateway is software that enables communication between computer networks that use different communications protocols or formats. A database is a structured set of data that is accessible in various ways and saved for use in the GUI. The GUI is a graphical user interface that allows users to interact with the tracking solution.

The solution includes a complete offering including but not limited to hardware, network and web application as a whole. The web application includes the user (GUI) interface that the user accesses with e.g. a unique web address (URL) and login credentials to view, display and interact with the hardware installed on the vehicles and/or other assets. A vehicle may be any commercial or private car, truck or van that can be operated on the roadway. In other embodiments, vehicles may be extended to air, water, and/or other vehicles.

Hardware includes devices installed/mounted on a vehicle or asset that transmits and receives data to and from tracking software and a back-end platform. A network is a wireless transport method used to deliver data to and from the hardware and the tracking software and back-end platform. The network may be either cellular or satellite technology.

The tracking software and back-end platform allows the end user to better manage and report on a vehicle or other asset by, for example, accessing a website for the tracking software twenty-four hours a day, seven days a week, using a smart phone mobile tracking software application, and/or by receiving reports and/or alerts from the tracking software platform via e.g. email, text message, etc. on a personal cell phone. Tracking software is a user interface (GUI) that the user accesses with a unique web address (URL) (or software application, etc.) to view, display and interact with the hardware installed on the vehicles or assets. The user is an owner of the hardware and/or person with authorization to view, display and interact with the tracking software and/or the solution. A mobile application is a tracking software application designed to run on smartphones, tablet computers and other mobile devices.

An alert is a warning or notification of a user of a possible breach or problem with a vehicle or asset, for correction of the problem.

The tracked assets may be refrigerated shipping containers (e.g. refrigerated truck trailers, refrigerated cargo ship containers, etc.). The hardware sensors may include one or more temperature sensors within the refrigerated containers. The hardware devices may include a GPS device. A user can track, display, report and control various information with the tracking software and back-end platform. For example, the user may view a live route-based dashboard with a snap shot of the day's (or other time period's) events, such as temperatures that fell outside of a set acceptable range (“temperature anomalies”). The user may view, on a map or in a table or other means of presentation, the locations where the temperature anomalies occurred and the conditions under which they occurred, such as the local outdoor temperature, driver, type of container, type, age, most recent maintenance, and other condition information relating to the refrigeration equipment, speed at which the container is travelling, outdoor weather conditions, acceleration/vibration information for the container, etc.

What constitutes a temperature anomaly may be fully customized by the user based on the user's particular application. For example, temperature anomalies may fall into different bands or categories based on various criteria. In an embodiment, a normal temperature reading might be coded green, while a temperature approaching a dangerous temperature may be coded yellow, a temperature at or just exceeding a dangerous temperature may be coded orange, and a temperature reading greatly exceeding a dangerous temperature may be coded red. Different categories of temperature anomalies may provoke different types of responses. For example, yellow temperature anomalies may result in logging, orange temperature anomalies may result in an alarm, while red temperature anomalies may cause alarms to be sent to a number of different parties with instructions for inspecting and/or destroying some of the refrigerated materials. Codings/categorizations may be based on many different factors in addition to temperature, such as the duration for which a temperature reading stayed within a certain range, the readings of other sensors within the same container, etc.

Temperature anomaly settings may be customized and saved as templates for use with certain types of assets and/or refrigerated transport containers. For example, a user may set certain settings for use as a default for refrigerated trailers in general, for refrigerated trailers carrying pharmaceutical cargo, for refrigerated shipping containers in general, etc. These settings may then be applied automatically if the container and/or cargo type are indicated when an asset is entered into the system. In embodiments, the user may adjust these default settings to further customize them at the individual asset and/or route level as desired (i.e. for a given refrigerated trailer and/or for one particular cargo delivery by the refrigerated trailer).

Temperature readings may be taken and stored continuously. Thus, a user may have access to full temperature information for a cargo over the course of its transportation. For example, the user may know the temperature reading at each sensor in the container for every second of the trip. In this way, the user knows not just whether a given temperature was exceeded, but by how much and for how long, and in what areas of the container. How much data is stored may also be completely user configurable. For example, the user may choose only to retain data pertaining to temperatures near and below a set temperature threshold. This avoids the cost of retaining data that is not useful because it shows the refrigeration equipment and other elements to be functioning properly. On the other hand, such information may be useful in evaluating the functioning of various elements of the refrigerated transport system, and so may be retained, for a limited duration or indefinitely.

Temperature anomaly settings may be customized for fleets, individual loads, and anything in between. A user may input the type of cargo carried in each tracked load, and may customize settings for each type of cargo. Settings may include a temperature at which damage to the cargo is likely, as well as a temperature at which damage to the cargo is possible and/or one or more other temperatures at which damage to the cargo is more or less likely. For example, a cargo of pharmaceuticals may be ruined if it reaches a temperature of 80° F. Since a sensor may not be mounted in contact with the cargo itself, there may be some temperature variation between the sensor location and the cargo. Thus, if a temperature reading of 80° F. is received from a sensor in the cargo container, there is a possibility that the cargo is ruined and must be discarded, but also a possibility that some or all of the cargo is still usable. As such, a reading of 80° F. may result in an alarm and instructions to assess the damage to the cargo, if the cargo is valuable enough to warrant such assessment and the assessment is practical, or to discard the cargo. A temperature reading of 90° F. however, may indicate a very high likelihood that all the cargo is destroyed, rendering an assessment wasteful and resulting in an alarm and instructions to dispose of the cargo. Readings across multiple sensors within a container, where sensor location information is known, may be used to model temperature progression through the container over time, for example using known temperature modeling software, and to identify the source of temperature anomalies. For example, an anomaly showing an elevated temperature spreading from the rear of a refrigerated trailer throughout the trailer may indicate that the rear trailer door was not secured properly and/or somehow opened during transport.

The level of customization may depend on the amount of information available to the user and the importance of accuracy in the given application. For example, if the exact locations of the sensor(s) and the cargo are known, this may be used together with the sensor temperature readings to estimate the probability that the temperature of the cargo is within some range. For example, if two sensors are on opposite sides of the cargo and each has the same reading, the likelihood that the cargo has also reached that temperature may be greater than if there is only one sensor. If a sensor is mounted within the cargo itself, the temperature sensed by that sensor may be considered to be the temperature of the cargo around it, depending on the size and shape of the cargo.

Information associated with temperature anomalies may allow the user to identify and address the sources of such anomalies. For example, if temperature anomalies are associated with high local outdoor temperatures, the cause may be insufficiently insulated refrigerated containers, underpowered refrigeration systems, etc. If temperature anomalies are associated with certain drivers, the driver may be failing to close the container properly, failing to set the refrigeration system up correctly, failing to properly monitor temperatures, etc. If temperature anomalies are associated with certain container types, those containers may be insufficiently insulated for the applications they are being used for. If temperature anomalies are associated with the type, age, most recent maintenance, and/or other condition information relating to the refrigeration equipment, that may indicate that the refrigeration equipment is underpowered for the application, is not being properly maintained, has aged excessively and required refurbishment or replacement, that the maintenance schedule for the equipment is insufficient for the application, etc. If temperature anomalies are associated with speed at which the container is travelling, outdoor weather conditions, and/or acceleration/vibration information for the container, that may indicate that the refrigeration equipment is malfunctioning or the container's integrity has been compromised due to a vehicular accident or other large forces acting on the equipment.

The information associated with temperature anomalies may be viewed/displayed in various manners. For example, the data may be in a table format, with each temperature anomaly sorted by date/time and containing other information associated with each anomaly such as temperature and duration, geographic location, outside temperature, driver, container, cargo, etc. This data may be exported for analysis by third-party software or analyzed using built-in tools that display the data visually in graphs (e.g. bar graphs of anomalies vs. driver or container type, line graphs of number of anomalies vs. outdoor temperature band, etc.) and identify outliers in the data (e.g. temperature anomalies that occurred at low outdoor temperatures).

Users may configure alarms and other information to be disseminated to various persons under various circumstances. The data may be made available to a remote monitor/operator, as well as to the local driver (or e.g. captain, in the case of a ship). Alerts may be sent to a driver via a smartphone app, SMS, automated voice calls, emails, via a dedicated in-cabin device, etc. Such alerts may notify the driver of temperature anomalies, as well as recommended courses of action. For example, the driver may be advised to inspect the refrigerated container and ensure that it is properly sealed, to inspect the refrigeration equipment and ensure that it is working properly, and/or to divert the container to a nearby facility for assistance with diagnosing and/or repairing the problem.

Generally, other sensors may be substituted and/or combined with temperature sensors in the above discussion for various applications. For example, accelerometers may be used to measure forces experienced by fragile shipping loads. Various thresholds may be set for forces experienced during transit, and various actions may be carried out depending on the threshold exceeded. For example, a force of 100 N may result in logging, a force of 1 kN may result in an alarm, and a force of 10 kN may result in multiple notifications and instructions to inspect or discard shipping contents. Measured forces may be used to determine if packaging is sufficient to protect various contents, whether drivers are being trained appropriately, etc. Force thresholds may be set and varied according to type of contents being shipped, mode of transportation, etc. Multiple accelerometers may be deployed throughout a shipping container to extrapolate forces experienced throughout a container. Moisture sensors may be used to detect levels of moisture in a shipment vulnerable to rot or other moisture-related damage. Thresholds may be set for acceptable levels of moisture over certain periods of time based on the contents and so forth. The same methods may be readily applied to any known sensor which may be useful for ensuring the safe delivery of some shipping load, and even extended to other applications besides shipping. For example, the same methods and logic may be deployed using medical sensors in healthcare applications, for example to track and analyze biomarkers in combat troops.

A user can track, display, report and control various information with the tracking software and back-end platform. For example, the user may view a live route-based dashboard with a snap shot of the day's (or other time period's) events, such as temperature anomalies. The user may view a live fleet-based dashboard with a snapshot of the day's events such as temperature anomalies. The user may track, display, report and store the history and/or current GPS position of assets, history of a current driver or operator of an asset, history of a current assigned route of an asset, associated information as discussed above, simultaneous views of all assets on one display screen (e.g. map overlay), monitored parameter reports such as individual trips, input and output data, routing and position data, history and/or current alerts from sensors, such as temperature violations, open door, tank level low or high, alarm system, panic button, etc., history and current alerts for speeding, geofence entry or exit, landmark arrival or departure, routing or rerouting of asset, independent third party or general public access and verification of asset location and assigned or scheduled routing.

The user may remotely control asset function, such as interrupting a circuit (e.g. starter disable), track, record, report etc. customer response time, receive alerts from an input panic button and view current or history status, receive alerts from an input alarm system and view current or history status, receive alerts from speeding or exceeding a predefined speed threshold, receive alerts from sensors (e.g. exceeding predefined output thresholds) and view current or history status, compare asset actual locations with asset actual destinations, save vehicle information including but not limited to make, model, year, color, license plate, yin number, size, capacity, fuel economy, etc., save driver information including but not limited to name, sex, address, phone number, cell phone carrier, email address, insurance information, state license information, etc., send and receive data using a communication means which is selected from the group consisting of: radio, cellular, digital radio, satellite, and the Internet, and compare, view and save a planned route and a route actually followed by an asset or vehicle.

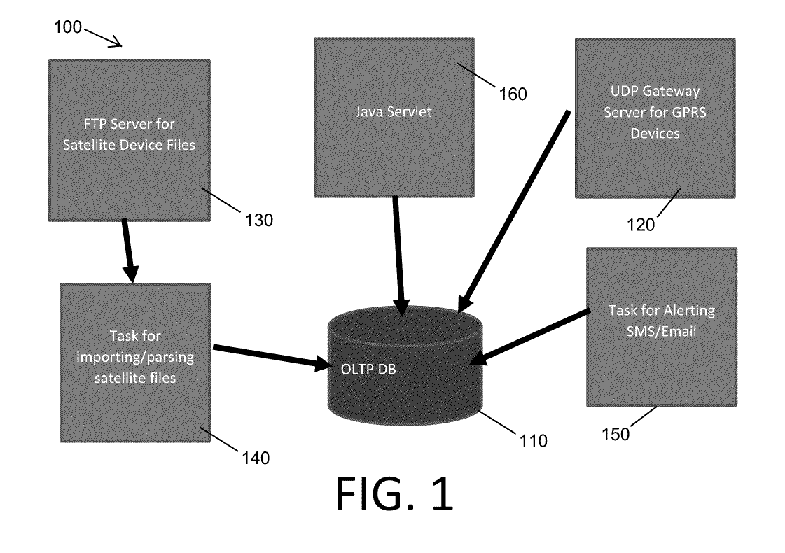

FIG. 1 is a diagram illustrating a back end architecture 100 for an asset tracking system, in an embodiment. The backend architecture consists of several components running on Windows 2008 R2 Server. A MySQL database 110 preserves all the transactional data (e.g. time-stamped position information). The database 110 also includes tables for historical and archive purposes and can easily be relocated to another database. A UDP Java Program 120 listens to GPS devices and parses the locate information and other sensor information from the cellular, GPS and/or satellite devices into the database. An FTP server 130 receives Global Satellites files for device information. A task 140 imports the Global Satellites files from the FTP Server to the database, parsing sensor and location information from the files. Java servlet 160 processed speeding, geofencing, and other exception-type alert notifications, which are then delivered to an end user via SMS or email by task 150, which runs a Java application that sends email or SMS notifications for configurable alerts.

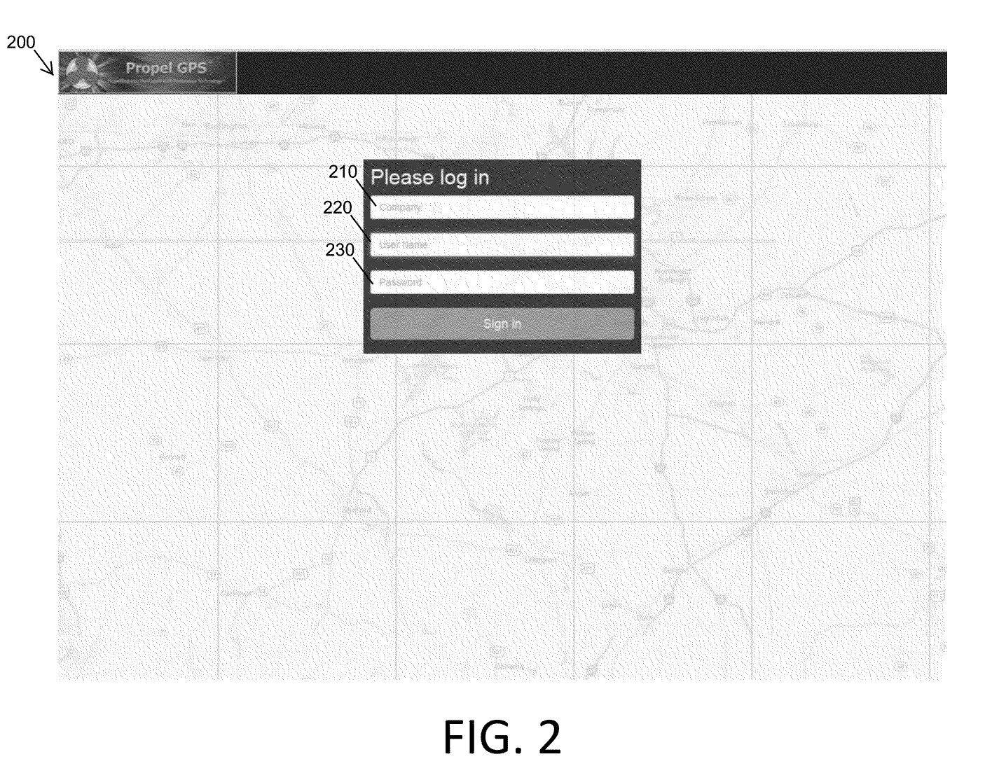

FIG. 2 is a screen shot illustrating a user login page 200 for tracking software, in an embodiment. Log-in fields include company 210, user name 220, and password 230 for a standard authentication process.

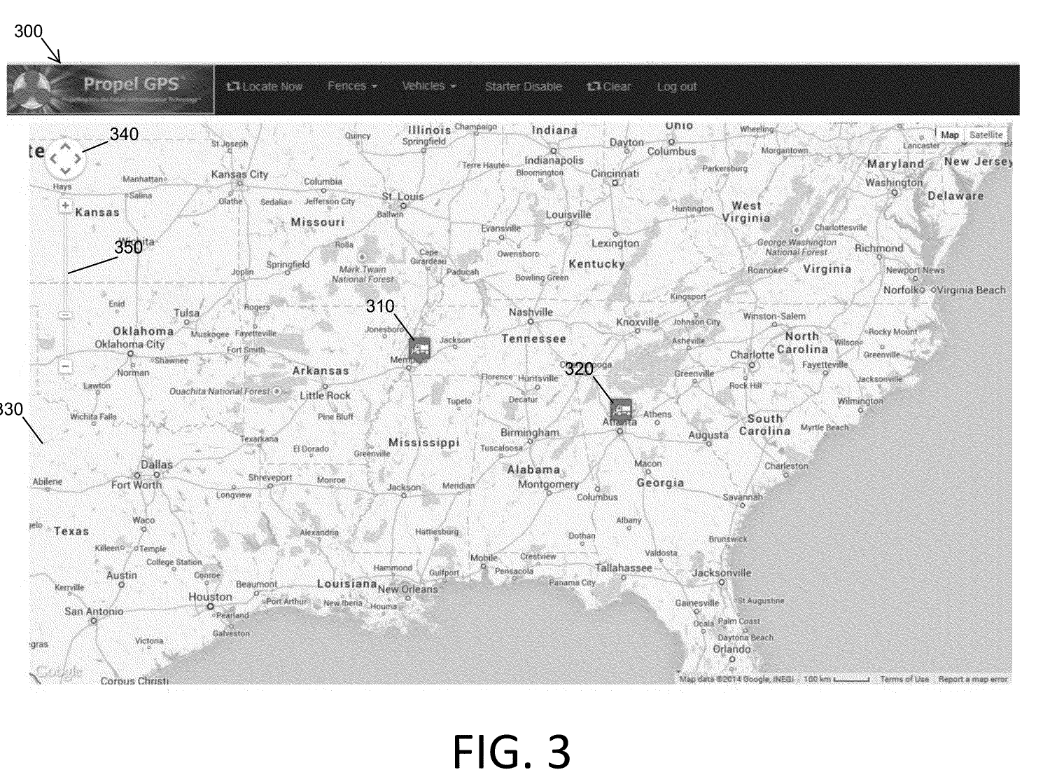

FIG. 3 is a screen shot 300 illustrating icons 310, 320 on a map 330 in an embodiment of a tracking software. To display asset information on the tracking software and back-end platform, an icon representing a vehicle (or other asset) is provided on a map. Here the map 330 is geographical, but in other embodiments may be a map of a structure or any location containing assets. If more than one vehicle is being tracked, then each vehicle may be represented by a unique icon 310, 320, which may differ from other icons in color, shape, and/or design. The icon is located on the map according to the geographical coordinates (raw data) received from hardware mounted on the asset. The provided maps may be provided by Microsoft or Google, registered photographs, scanned photographs, and/or from some other geographic map source. The maps may include but are not limited to digital maps, scanned maps, aerial photographs, and the like. Using the tracking software, a user can manipulate the maps to observe different areas, vehicles/assets, landmarks, and other features. The user can search for different locations, pan to different areas on a map using e.g. pan controls 340, and zoom in or out of an area or around an asset using e.g., zoom controls 350. The tracking software also provides data about the fleet, vehicles, assets, drivers and other relevant information.

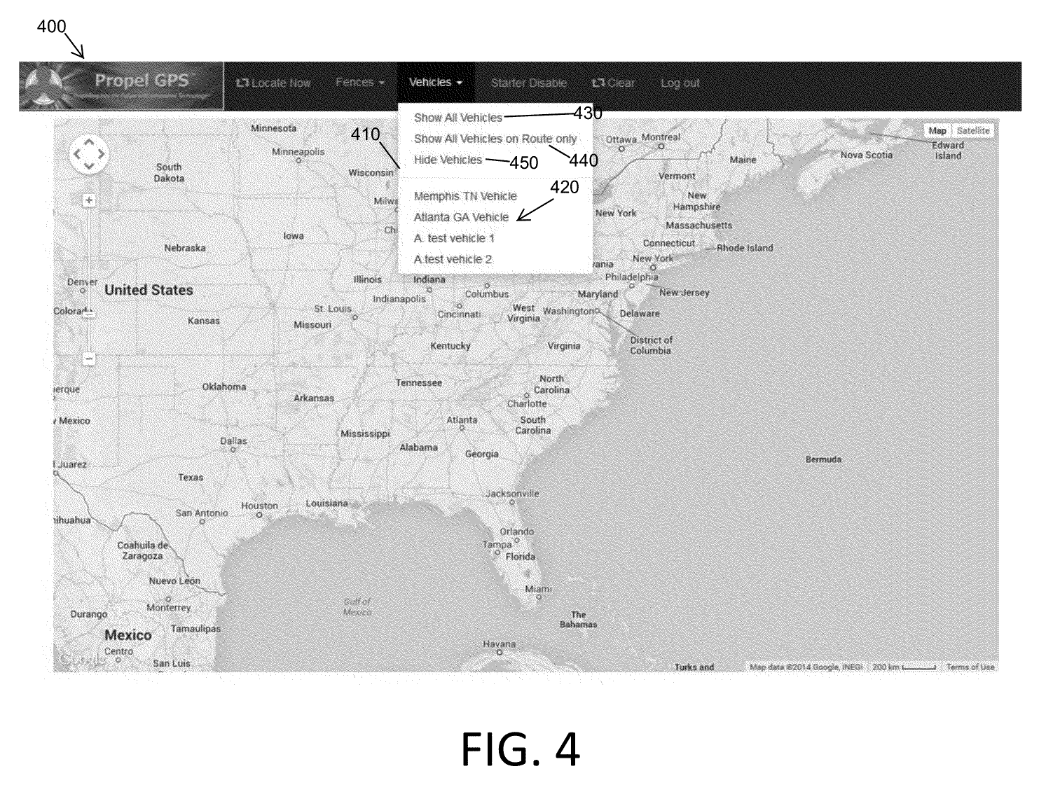

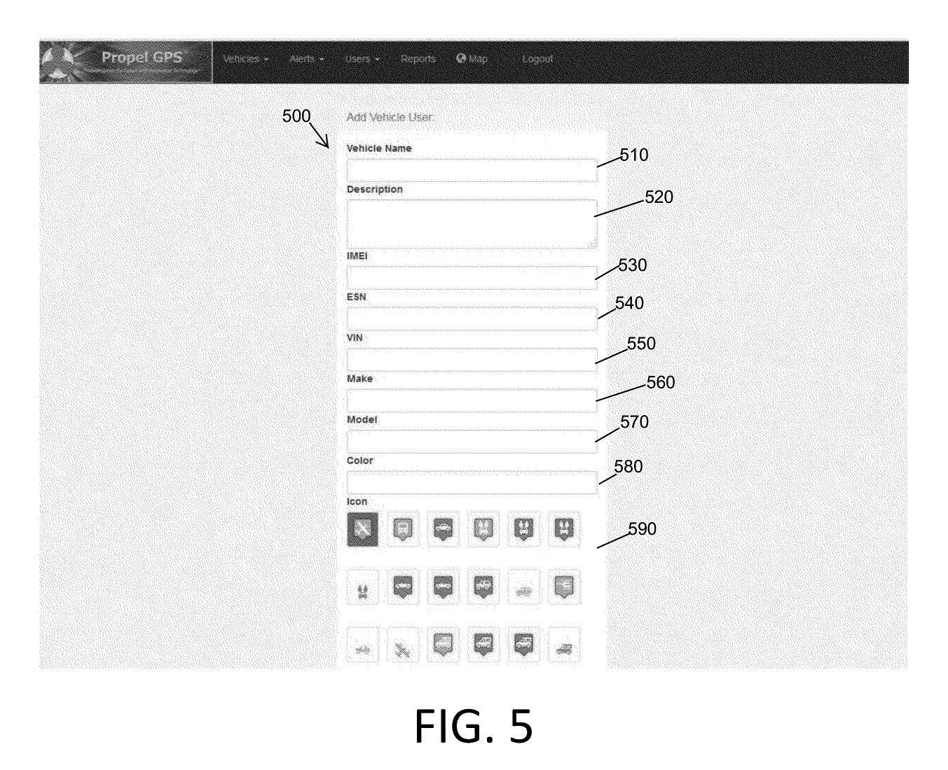

FIG. 4 is a screen shot 400 containing information on all the vehicles or assets in a specific account, in an embodiment of a tracking software. The vehicle information drop down 410 displays data on all of the vehicles in the fleet. The drop down 410 has options for the user to show all vehicles on the map 430, show all vehicles currently on a scheduled route on the map 440, or hide all vehicles 450 so they are not shown on the map. The drop down information includes a drop-down list 420 of all the vehicles in the fleet account. When a vehicle is selected from the list, the information displayed includes, but is not limited to, the following fields: vehicle id, make, model, year, state, type, color, phone, and driver. In other embodiments, some or all of this information may be displayed directly in the drop-down list, which may be user-configurable. A driver information link for a driver linked to the vehicle information is linked to driver information, which is described with regard to FIG. 5 below.

FIG. 5 is a screen shot showing a vehicle user and related driver information set up screen 500, in an embodiment of a tracking software. This screen may be used to set up a new vehicle user for display on the map (e.g. of FIG. 3), for example when a new vehicle is deployed, tying vehicle information to position data associated with deployed hardware and with a display icon. The vehicle name field 510 is an optional name identifying the vehicle, e.g. “Charley's car.” The description field 520 is an optional text field for the user to enter other identifying information. The IMEI field 530 is a unique hardware serial identification number associated with the hardware installed on the vehicle. The ESN field 540 is the unique hardware identification number that provides a singular footprint for a specific device. The VIN field 550 is for the vehicle or asset's unique identification number. The make field 560 is for the vehicle's manufacturer. The model field 570 is for the current vehicle's model. The year field is the year the vehicle was manufactured. The color field 580 is the color of the vehicle. The driver field (not shown) is the driver assigned to the vehicle when selected as an option. The icon field 590 is the icon assigned to the vehicle for display on the map (as in e.g. FIG. 3).

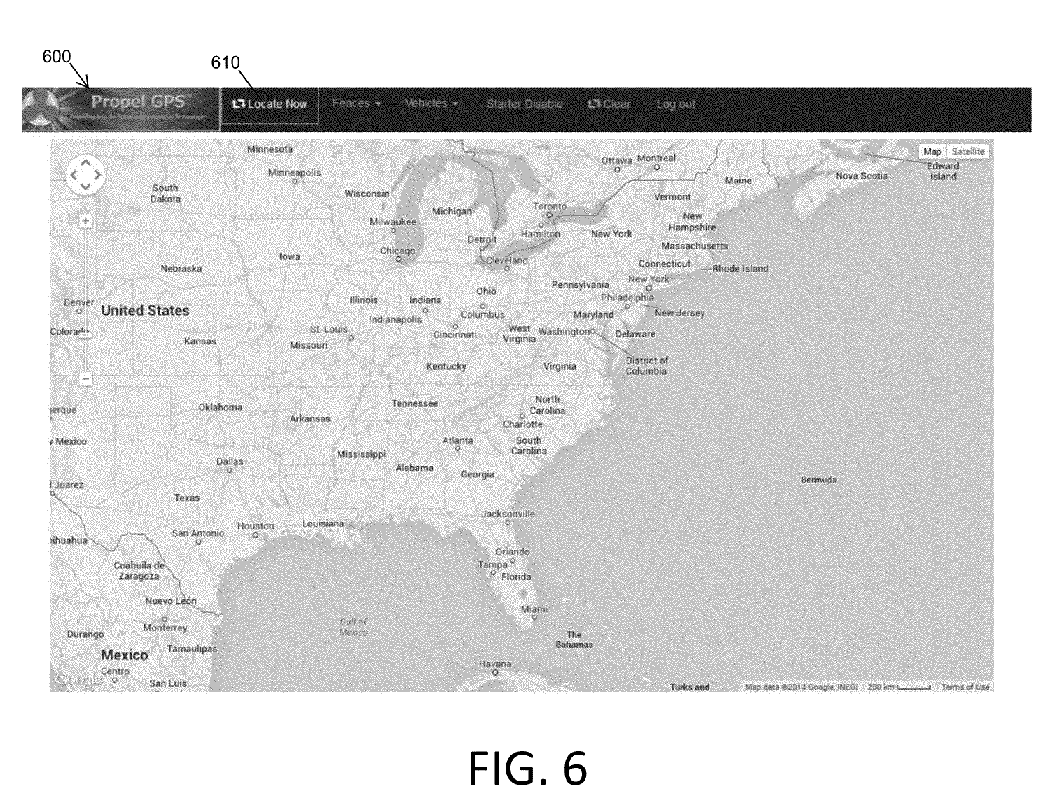

FIG. 6 is a screen shot 600 showing a “Locate now” icon 610, in an embodiment of a tracking software. The “locate now” functionality gives the user the ability to send an immediate request to the hardware for a current location of an asset. The hardware returns the GPS position data and the corresponding icon is displayed on the map along with the raw latitude and longitude data and the reverse geo coded address of the asset or vehicle. In other embodiments, the positional data displayed may vary, and/or may be user-selectable. The asset to be located using the “locate now” functionality in embodiments may be selected in a popup or dropdown after selecting the “locate now” icon, or may have been previously selected for example from the vehicle dropdown.

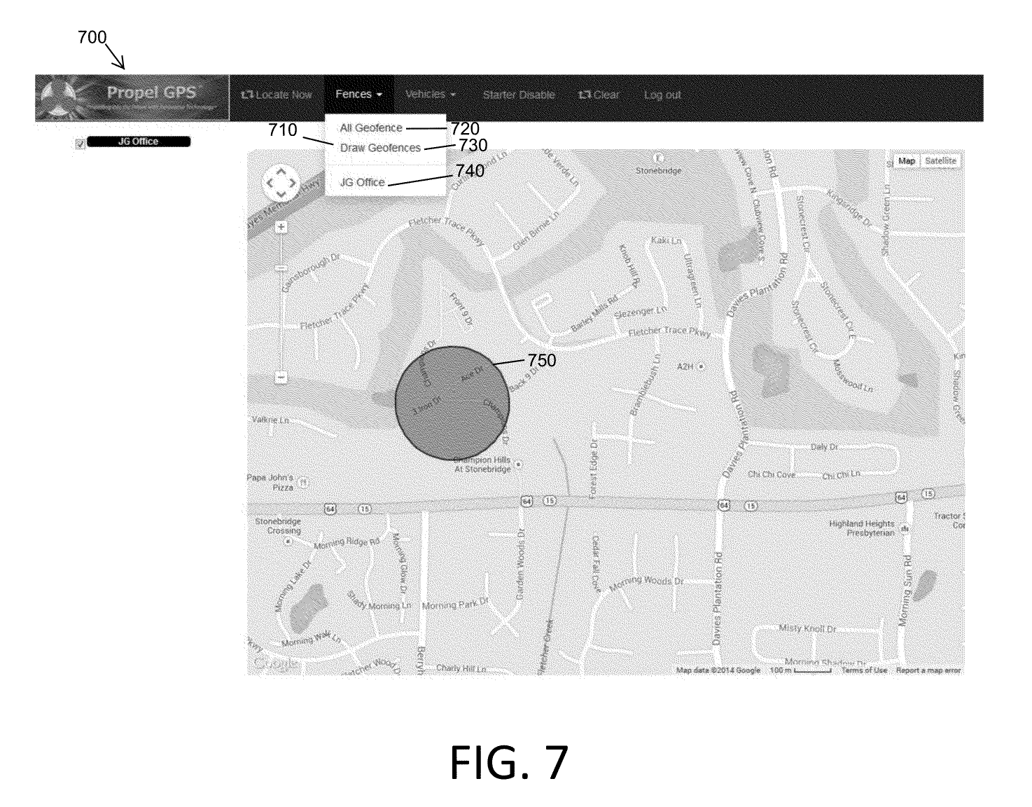

FIG. 7 is a screen shot 700 of a Geo Fence capability, in an embodiment of a tracking software. A geo fence is a virtual border or predefined location that can be monitored for entry and exit traffic. When an asset crosses the predefined virtual border a user may be notified immediately via email or text message on a personal cell phone and/or via the tracking software and back-end platform in the form of a pop-up message displayed on the screen. In other embodiments, notifications may be sent in any known manner and with any timing, and the method of notification, frequency of notification, etc. may be user-selectable. In some embodiments geo-fence crossings are recorded for later processing and no notifications are sent.

Geo-fence functionality is accessed via the Fences drop-down 710. All Geofence 720 may be selected to display all the geofences on the map that a user has currently set up and saved. Draw Geofence 730 allows the user of the tracking software the ability to create their own unique geofence, for example by drawing the desired virtual boundary on the map with an input such as a mouse pointer or touch input (for a touch screen). Boundaries may be drawn freehand or in preset shapes such as circles, squares, etc. using any known software drawing tools. The name “JG Office” 740 represents a current geofence created by a user. The grey circle 750 is the map display of the geofence named “JG Office.” The “JG Office” selection on the drop-down may be used to toggle this map display on or off, which may also toggle the geo-fence itself on and off (e.g. when not shown on the map, the geo-fence may be inactive and notifications may not be sent when it is crossed).

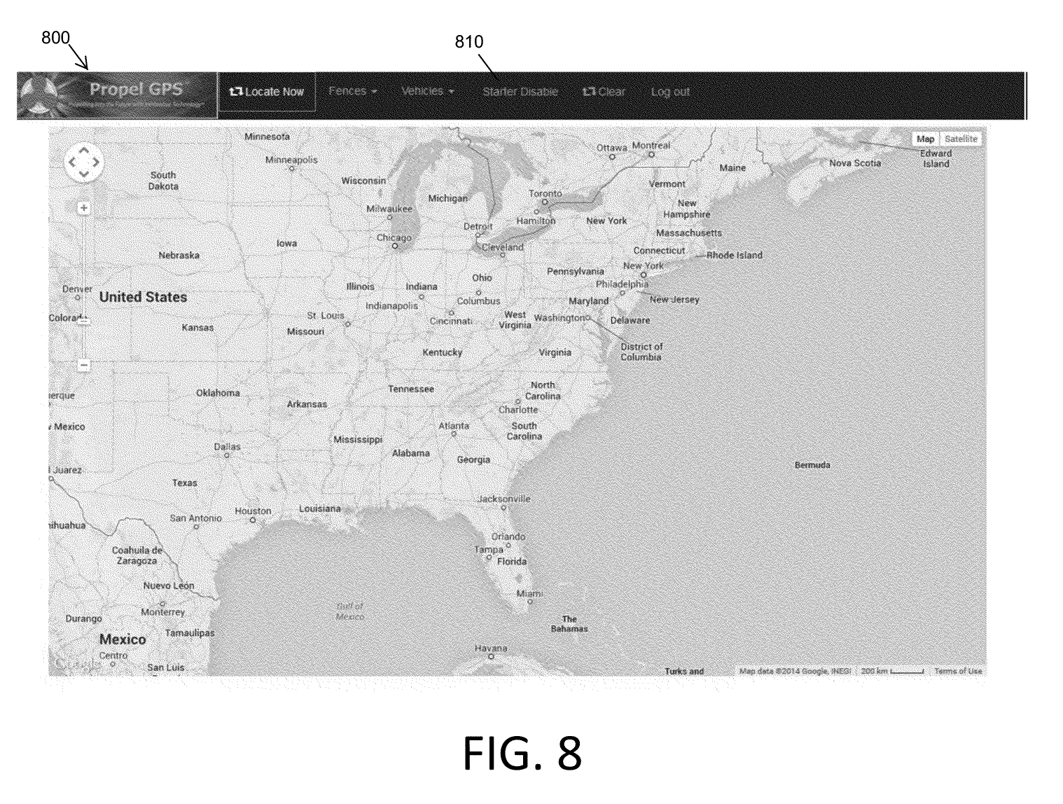

FIG. 8 is a screen shot 800 showing a starter disable function 810, in an embodiment of a tracking software. The starter disable function 810 allows the user of the tracking software and back-end platform the ability to remotely control the vehicle or asset by disconnecting or interrupting the current flow of a circuit, such as a starter circuit on a vehicle. The vehicle or asset has an interposing relay installed that can be opened and closed remotely that controls the flow of electricity to the circuit. The starter disable 810 is unselectable until an asset/vehicle is selected from the map or drop-down, after which the starter disable function 810 may become available for disabling the selected asset. NOTE: In this embodiment the vehicle or asset cannot be disabled if the engine is already running (on) when the signal is sent to disable the circuit, for safety reasons. This same remote circuit-control functionality may be used in other applications (e.g. with different assets), for example to prevent theft or unauthorized access to mobile assets.

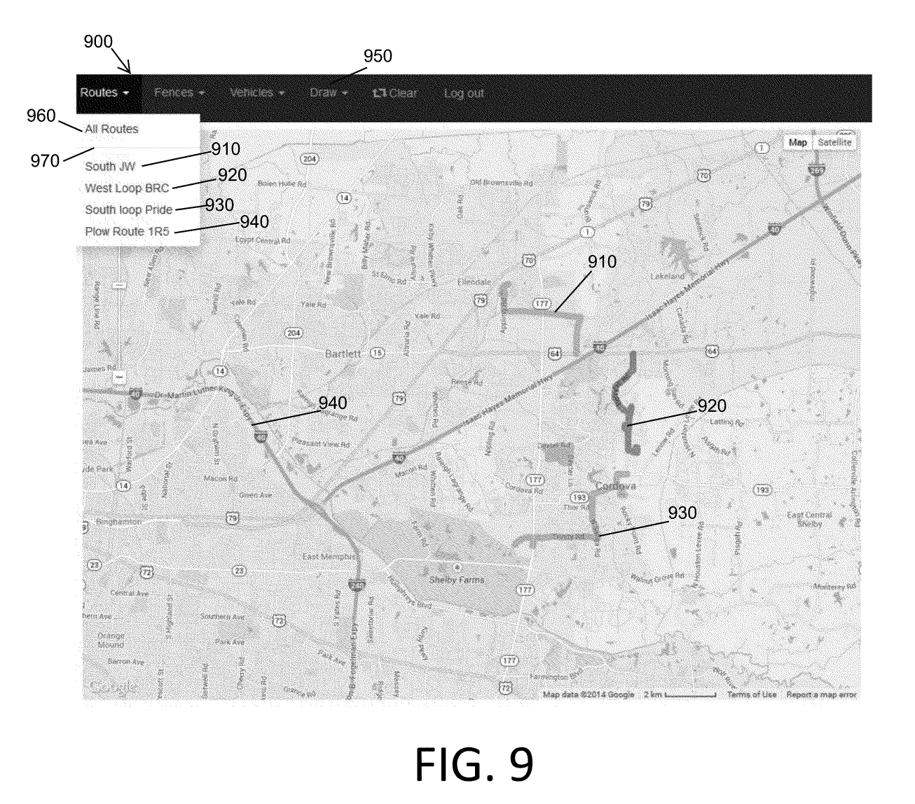

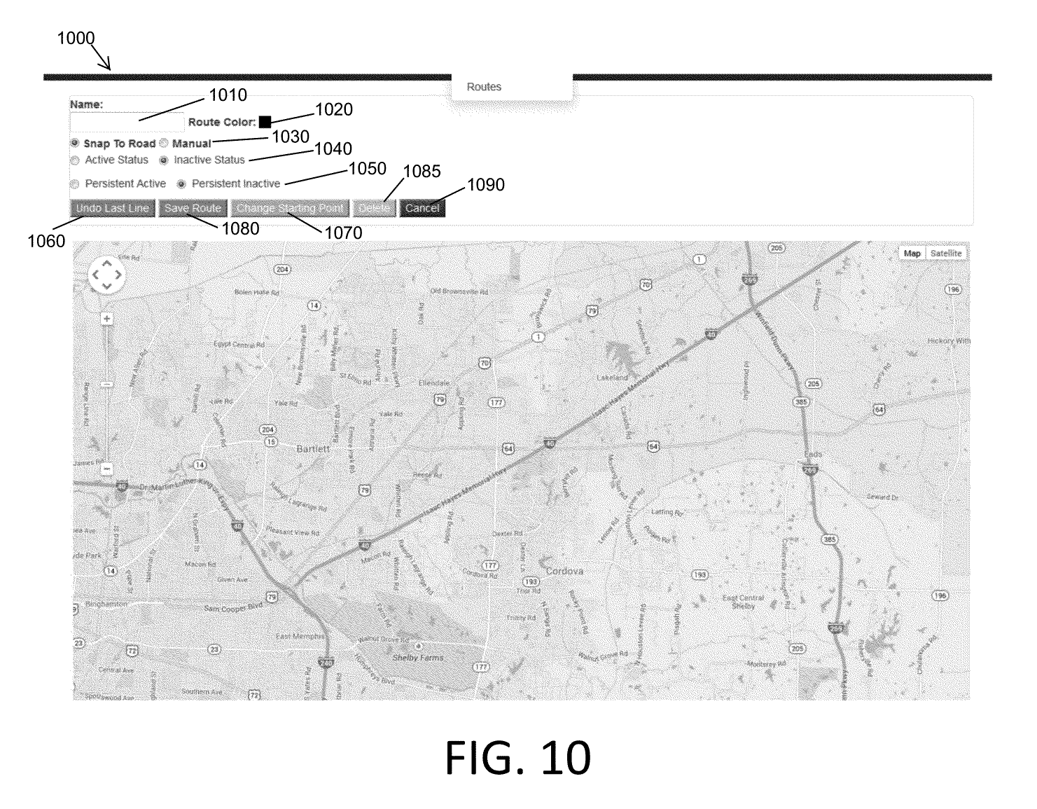

FIG. 9 is a screen shot 900 showing user-created designated routes 910, 920, 930, 940 which are followed by one or more vehicles or assets on a regular basis, in an embodiment of a tracking software. A route can be created by a user and saved to the tracking software and back-end platform to be viewed and assigned to a driver. Unique routes 910, 920, 930, 940 are displayed and may be differentiated based on color. In some embodiments, the lines may have various patterns such as dashes or other shapes to aid in distinguishing one from another, particularly where large numbers of routes are displayed at once. The Routes dropdown 970 shows four unique routes 910, 920, 930, 940 that have been created and displayed (one in pink 910, one in gray 920, one in blue 930 and one in orange 940). A user can create routes by clicking on the map and on associated streets that are part of a specific route. For example, the user may select the Draw dropdown 950 to draw a route on the displayed map as illustrated in FIG. 10. Once the route-drawing is finished, the user may input route information associated with the drawn route, including the route name and other desired information, and may assign one or more drivers to the route. Multiple routes may be created and named accordingly for quick identification. Routes can be viewed individually or simultaneously. For example, routes may be toggled on or off the display individually by selecting the individual route names 910, 920, 930, 940 from the dropdown, while selecting All Routes 960 from the dropdown may toggle all routes on or off simultaneously. Further, vehicles or assets can be displayed only when on an assigned route such as a trash pickup standard route and/or the route status is viewed by a third party or the general public on a unique web address by which to log in remotely.

FIG. 10 is a screen shot showing a route set-up page “Draw” 1000 that allows the user to create and edit routes, in an embodiment of a tracking software. The user can set the route name using name field 1010 and a color for the route when displayed using color field 1020, and choose whether to snap the drawn route to roads on the map using snap selector 1030. Status selector 1040 may be used to change the route to active or inactive status and persistent status selector 1050 may be used to change the route between persistent active and persistent inactive status. The user may use a mouse or other input to select points for the route on the map, undo route segments using button 1060, change a starting point for the route using button 1070, and save a completed route for display and driver assignment using button 1080. Buttons 1085, 1090 may be used to delete a route and cancel a route in the process of being created, respectively.

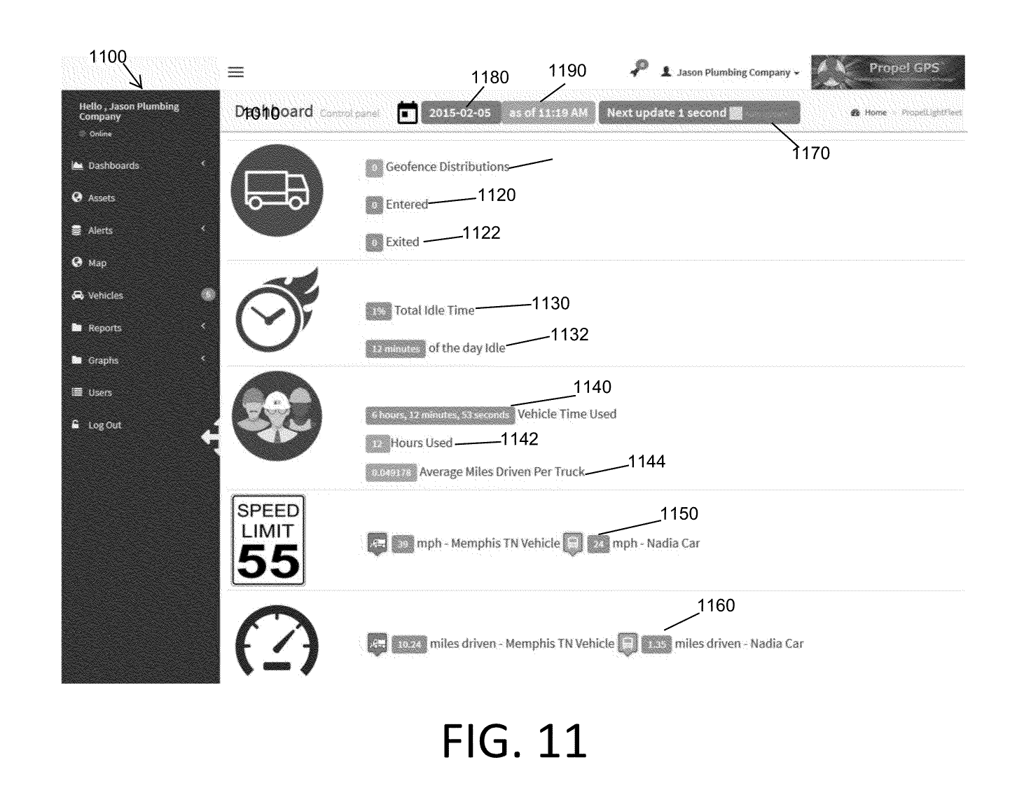

FIG. 11 is a screen shot 1100 showing a Fleet Dashboard 1110, in an embodiment of a tracking software. This dashboard is a live (updated every 1 minute) snapshot of the day's events such as geofence entries and exits 1120,1122, total number of geofence alerts sent for the user-selected date and time period displayed 1124, engine idle time percentage and amount 1130,1132, total time (hours, minutes, seconds) the fleet vehicles were used today, total hours passed in the day so far, and average miles driven today per vehicle 1140,1142,1144, top speed of the day 1150 for each vehicle in the fleet and miles driven of the current day 1160 for each vehicle in the fleet. In embodiments, this information may be presented for each vehicle/asset in the fleet separately and/or for the entire fleet combined. A user may select specific assets/vehicles from the fleet to view the statistics for those assets only. In embodiments, the frequency of updating 1170 may vary and/or be user-selectable, as may the time period covered by the snapshot (e.g. day, month, year, etc.). Date 1180 and time 1190 of the dashboard report are displayed for reference.

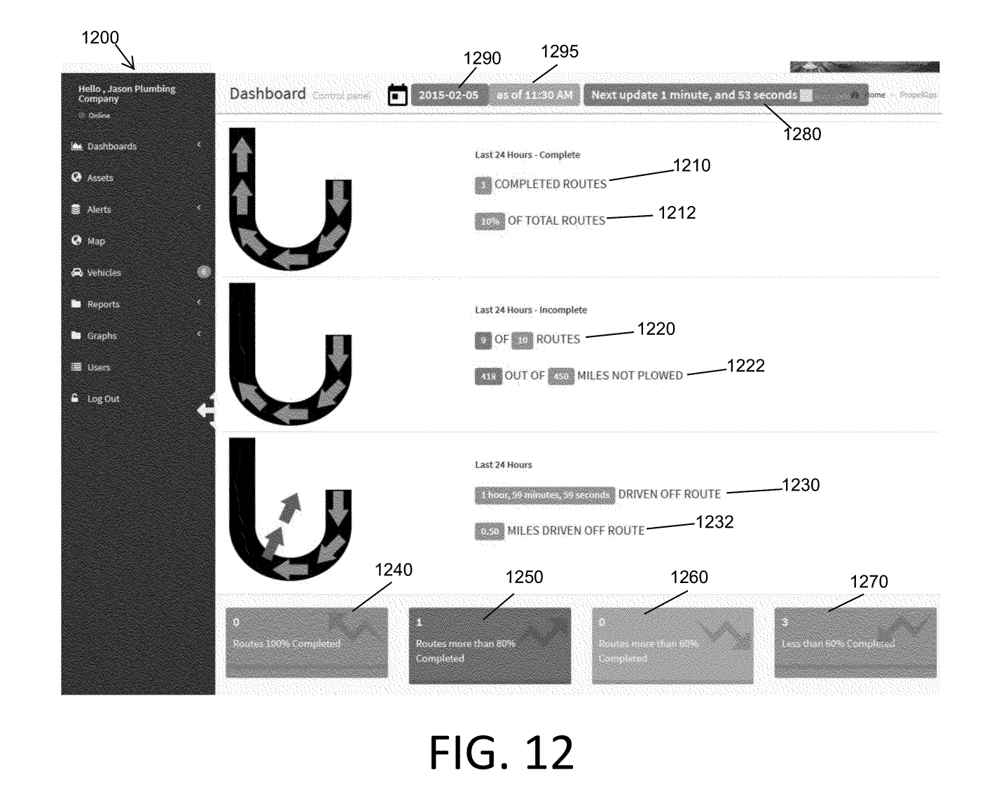

FIG. 12 is a screen shot 1200 of a Route Utilization dashboard, in an embodiment of a tracking software. This dashboard is a live (updated every one minute) snap shot of the day's events such as number of completed routes 1210 and completion percentage of total routes assigned 1212, number of incomplete routes 1220 and incomplete proportion of total route miles assigned 1222, time driving off routes 1230 and miles driven off route 1232, and time driving on assigned routes. In the screen shot shown, one route was completed and ten routes were assigned, with drivers spending a total of almost two hours driving 0.5 miles off their assigned route. At the bottom of the screen, color codes 1240, 1250, 1260, 1270 are shown, indicating that 100% completed routes are shown in blue, 80%+ completed routes in green, 60%+ completed routes in orange, and less than 60% completed routes in red, with the number of each type of route for the time period covered (here 24 hours). In embodiments, this information may be presented for each vehicle/asset in the fleet separately and/or for the entire fleet combined. A user may select specific assets/vehicles from the fleet to view the statistics for that asset only. In embodiments, the frequency of updating 1280 may vary and/or be user-selectable, as may the time period covered by the snapshot (e.g. day, month, year, etc.). Date 1290 and time 1295 of the dashboard report are displayed for reference.

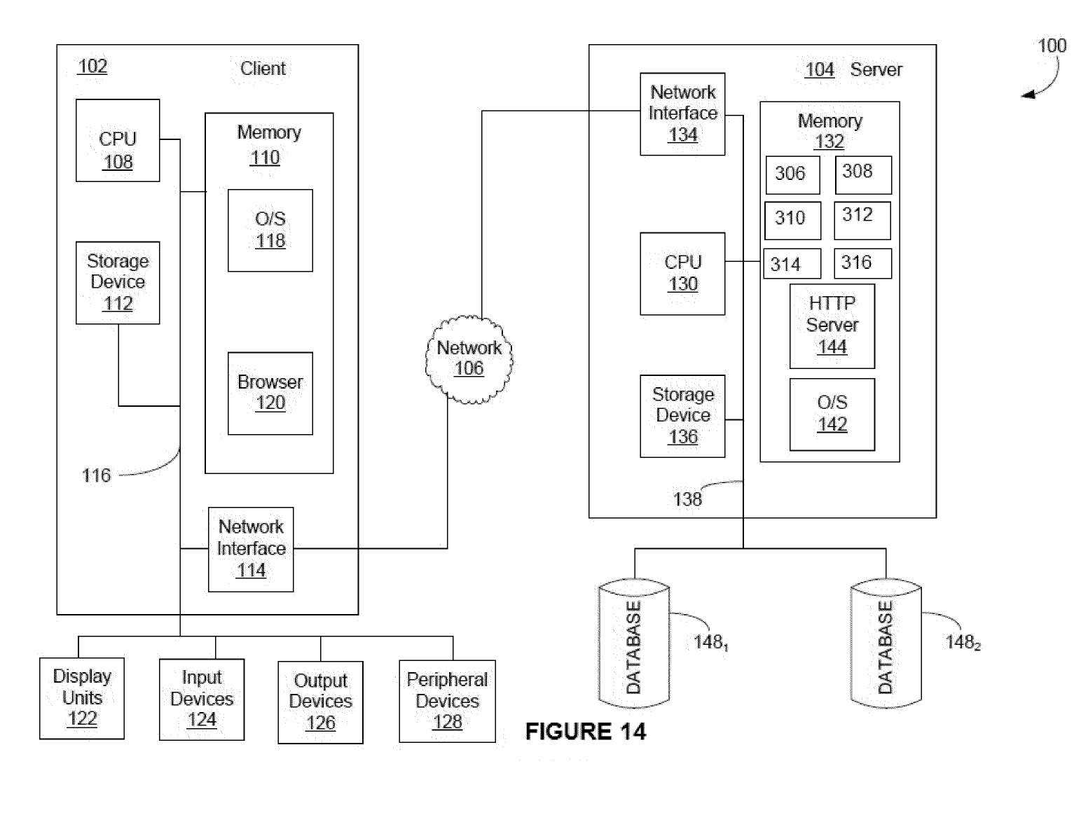

One embodiment of the invention is implemented as a program product for use with a computer system such as, for example, the computing environment 100 shown in FIG. 14 and described below. The program(s) of the program product defines functions of the embodiments (including the methods described herein) and can be contained on a variety of signal-bearing media. Illustrative signal-bearing media include, but are not limited to: (i) information permanently stored on non-writable storage media (e.g., read-only memory devices within a computer such as CD-ROM disks readable by a CD-ROM drive); (ii) alterable information stored on writable storage media (e.g., floppy disks within a diskette drive or hard-disk drive, solid state storage devices); and (iii) information conveyed to a computer by a communications medium, such as through a computer or telephone network, including wireless communications.

The latter embodiment specifically includes information downloaded from the Internet and/or other networks. Such signal-bearing media, when carrying computer-readable instructions that direct the functions of the present invention, represent embodiments of the present invention. In general, the routines executed to implement the embodiments of the invention, may be part of an operating system or a specific application, component, program, module, object, or sequence of instructions. The computer program of the present invention typically is comprised of a multitude of instructions that will be translated by the native computer into a machine-readable format and hence executable instructions. Also, programs are comprised of variables and data structures that either reside locally to the program or are found in memory or on storage devices.

In addition, various programs described hereinafter may be identified based upon the application for which they are implemented in one or more specific embodiments of the invention. However, it should be appreciated that any particular program nomenclature that follows is used merely for convenience, and thus the invention should not be limited to use solely in any specific application identified and/or implied by such nomenclature. In this regard, references to particular definitional languages, such as HTML and XML, are illustrative in nature and do not serve to limit the claims. It is broadly contemplated that the invention is applicable regardless of the particular schema and/or language used to define network resource content.

Turning now to FIG. 14, a block diagram illustrating an exemplary computing environment 100, in accordance with an embodiment of the present invention, is shown. In general, the computing environment 100 includes a client (e.g., a user's) computing device (e.g. smartphone) 102, and a server computer 104. The client computing device 102 and the server computer 104 may be components of the same computer system or may be connected via a network 106, such as the Internet. There may be multiple client computing devices 102 (e.g. purchaser and merchant).

As shown, the client computing device 102 includes a central processing unit (CPU) 108 connected to a memory 110, a storage device 112, and a network interface 114 via a bus 116. The CPU 108 is included to be representative of a single CPU, multiple CPUs, a single CPU having multiple processing cores, and the like. The storage device 112 stores application programs and data for use by the client computing device 102. Examples of the storage device 112 include one or more hard-disk drives, flash memory devices, optical media and the like.

The client computing device 102 may be connected to the data communications network 106 (e.g., a local area network, which itself may be connected to other networks such as the internet) using the network interface 114. The memory 110 can be one or a combination of memory devices, including random access memory, nonvolatile or backup memory (e.g., programmable or flash memories, read-only memories, etc.). Illustratively, the memory 110 of client computing device 102 stores an operating system 118 used to manage hardware and software executing on the client computing device 102. As shown, memory 110 also includes a browser program 120 which, when executed by CPU 108, provides support for navigating between various servers and locating network addresses at one or more of servers (e.g., server computer 104). Memory 110 may also contain a local software application (not shown) for facilitating communication with the server 104.

The client computing device 102 may be connected to one or more display units 122, input devices 124, output devices 126 and peripheral devices 128. The display units 122 may be internal or external monitors, television screens, handheld device displays, and the like. The input devices 124 may be any one of a touch screen, keyboard, mouse, track-ball, stylus, mouse pad, mouse button, joystick, scanner or the like. The output devices 126 may be any one of a monitor, printer, plotter, copier or other output device. The peripheral devices 128 may be any other device which can be coupled to a computing device: a CD/DVD drive capable of reading and/or writing to physical digital media, a USB device, Zip Drive, external floppy drive, external hard drive, phone and/or broadband modem, router/gateway, access point and/or the like.

Similar to the client computing device 102, the server computer 104 may include a CPU 130, a memory 132, a network interface device 134, and a storage device 136, coupled via a bus 138. The memory 132 may be a random access memory sufficiently large to hold the necessary programming and data structures that are located on the server computer 104. As shown, the memory 132 stores an operating system 142 used to manage server hardware and software executing on the server computer 104. Illustratively, the memory 132 also includes a hypertext transfer protocol (http) server 144 configured to service requests from the client computing device 102. For example, the http server 144 may respond to requests for access to electronic resources (e.g., HTML documents, network information, and the like) residing on the server computer 104. However, one of ordinary skill in the art will recognize that the http server 144 is merely illustrative and embodiments of the invention may be adapted to support both known and unknown protocols.

The programming and data structures of the http server 144 may be accessed and executed by the CPU 130 as needed during operation. The server computer 104 may connect to the network 106 using the network interface device 134 (e.g., an analog modem, a wired network card, or a wireless network device).

In one embodiment, users may interact with the server computer 104 using a graphical user interface (GUI). In a particular embodiment, GUI content may comprise HTML documents (i.e., web pages) rendered on the display unit 122 coupled with the client computing device 102 using the browser 120. In one embodiment, the web pages may include pages that allow a user to register a user account and upload user account information.

The memory 132 may further include modules 306, 308, 310, 312, 314, 316 such as a communications module, a display module, an asset information module, a temperature anomaly module, a temperature anomaly criteria customization module, a dashboard module. The modules 306, 308, 310, 312, 314, 316 may comprise a software application configured to track and manage remote assets and particularly refrigerated transport containers.

Accordingly, the server computer 104 may be coupled to a plurality of databases 148₁, 148₂ which may include a relational database 148₁ that is queried using an SQL query, or an XML database 148₂ queried using an XML query. The invention, however, is not limited to any particular physical database storage mechanism and may readily be extended to operate on other such mechanisms, whether currently known or unknown. While the databases 148₁, 148₂ are illustrated as being external to the server system, it is noted that the databases 148₁, 148₂ may exist on a local storage device (e.g., storage device 136) of the server computer 104, or may be accessed over the network 106.

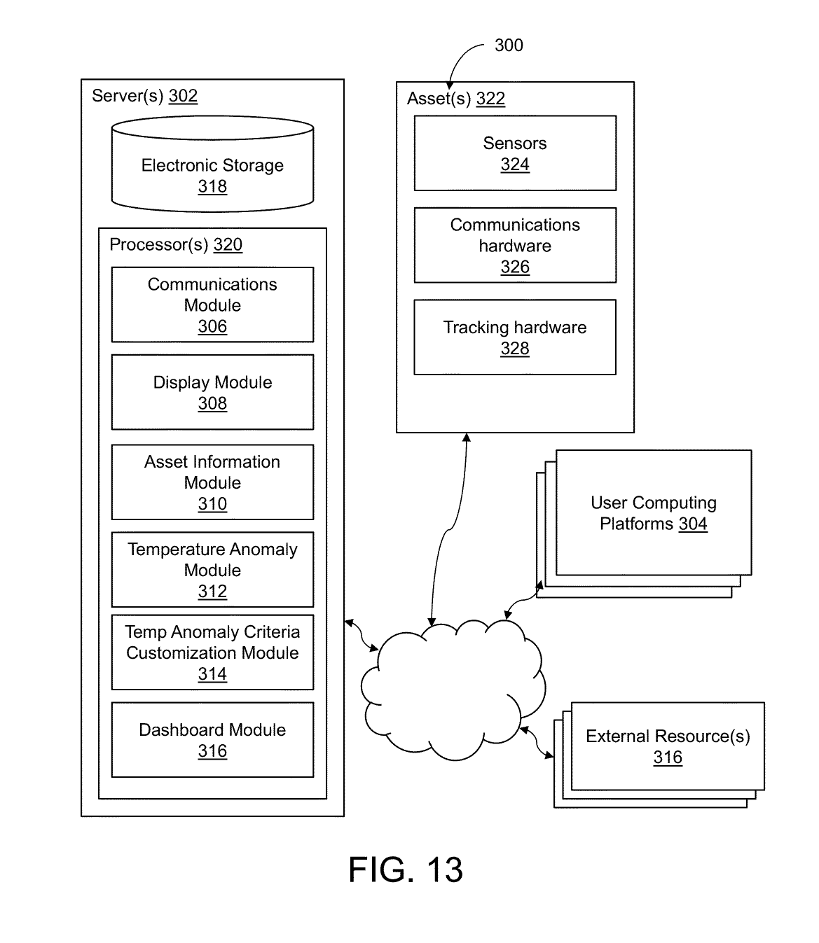

FIG. 13 illustrates a system 300 configured to track and manage remote assets, and in particular refrigerated transport containers, in accordance with one or more implementations. In some implementations, system 300 may include one or more servers 302. The server(s) 302 may be configured to communicate with one or more user computing platforms 304 according to a client/server architecture. The users may access system 300 via client computing platforms 304 (e.g. computer, smartphones), for instance, to track and manage remote assets.

The server(s) 302 may be configured to execute one or more computer program modules. The computer program modules may include one or more of a communications module 306, a display module 308, an asset information module 310, a temperature anomaly module 312, a temperature anomaly criteria customization module 314, a dashboard module 316, and/or other modules. As noted, the client computing platforms 304 may include one or more computer program modules that are the same as or similar to the computer program modules of the server(s) 302 to carry out similar functions locally.

Communications module 306 may be configured to receive requests for data from remote user computing devices and to transmit requested data to the remote user computing devices, as well as to transmit and receive data and instructions with assets 322.

Display module 308 may be configured to display the requested data on the remote user computing device, including displaying data from the positioning sensor overlaid on a map to indicate a position of the asset.

Asset information module 310 may be configured to receive asset information from the remote user computing device and associate it with the asset, wherein the asset information includes graphics for display on the map as part displaying the data from the positioning sensor.

Temperature anomaly module 312 may be configured to receive temperature anomaly criteria from the temperature anomaly criteria customization module 314 and temperature readings from asset sensors and send a notification when temperature readings indicate that the asset crosses a temperature boundary. For example, temperature anomaly module 312 may receive one or more temperature sensor readings from an asset, compare it with temperature anomaly criteria from temperature anomaly criteria customization module 314 to determine whether the readings qualify as a temperature anomaly, and if so, carry out appropriate actions such as indicating the anomaly on the user's display map by color code, sending a direct notification to the driver and/or user by e.g. SMS, etc.

Temperature anomaly criteria customization module 314 may be configured to receive information relating to allowable temperatures from the remote user computing devices and to create temperature anomaly criteria and transmit them to the temperature anomaly module 312. Temperature anomaly criteria customization module 314 may carry out for users all the temperature setting customization functionality discussed above, such as setting temperature bands and automatic actions associated with temperature readings falling into each band, setting varying notifications and instructions depending on temperature readings and duration, assigning different temperature settings to different assets and asset types, setting who is notified of temperature anomalies and how, setting what data is retained for analysis and for how long, etc.

Dashboard module 316 may be configured to display a time-period data summary on the remote user computing device detailing information associated with the asset position over a set period of time and to display a route summary on the remote user computing device detailing compliance with temperature limits (among other factors) over the time period.

In some implementations, server(s) 302, client computing platforms 304, and/or external resources 316 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which server(s) 302, client computing platforms 304, and/or external resources 316 may be operatively linked via some other communication media.

A given client computing platform 304 may include one or more processors configured to execute computer program modules. The computer program modules may be configured to enable an expert or user associated with the given client computing platform 304 to interface with system 300 and/or external resources 316, and/or provide other functionality attributed herein to client computing platforms 304. By way of non-limiting example, the given client computing platform 304 may include one or more of a desktop computer, a laptop computer, a handheld computer, a netbook, a smartphone, a gaming console, and/or other computing platforms.

The external resources 316 may include sources of information, hosts and/or providers of web sites outside of system 300, external entities participating with system 300, and/or other resources. In some implementations, some or all of the functionality attributed herein to external resources 316 may be provided by resources included in system 300.

The server(s) 302 may include electronic storage 318, one or more processor(s) 320, and/or other components. The server(s) 302 may include communication lines, or ports to enable the exchange of information with a network and/or other computing platforms. Illustration of server(s) 302 in FIG. 3 is not intended to be limiting. The server(s) 302 may include a plurality of hardware, software, and/or firmware components operating together to provide the functionality attributed herein to server(s) 302. For example, server(s) 302 may be implemented by a cloud of computing platforms operating together as server(s) 302.

Electronic storage 318 may comprise electronic storage media that electronically stores information, including user account information such as name, login information, registered phone information, payment information, user settings, funds in the user account, etc. The electronic storage media of electronic storage 318 may include one or both of system storage that is provided integrally (i.e., substantially non-removable) with server(s) 302 and/or removable storage that is removably connectable to server(s) 302 via, for example, a port (e.g., a USB port, a firewire port, etc.) or a drive (e.g., a disk drive, etc.). Electronic storage 318 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storage 318 may include one or more virtual storage resources (e.g., cloud storage, a virtual private network, and/or other virtual storage resources). Electronic storage 318 may store software algorithms, information determined by processor(s) 320, information received from server(s) 302, information received from client computing platforms 304, and/or other information that enables server(s) 302 to function as described herein.

Processor(s) 320 is configured to provide information processing capabilities in server(s) 302. As such, processor(s) 320 may include one or more of a digital processor, an analog processor, a digital circuit designed to process information, an analog circuit designed to process information, a state machine, and/or other mechanisms for electronically processing information. Although processor(s) 320 is shown in FIG. 3 as a single entity, this is for illustrative purposes only. In some implementations, processor(s) 320 may include a plurality of processing units. These processing units may be physically located within the same device, or processor(s) 320 may represent processing functionality of a plurality of devices operating in coordination. The processor(s) 320 may be configured to execute modules 306, 308, 310, 312, 314, 316 and/or other modules. The processor(s) 320 may be configured to execute modules 306, 308, 310, 312, 314, 316 and/or other modules by software; hardware; firmware; some combination of software, hardware, and/or firmware; and/or other mechanisms for configuring processing capabilities on processor(s) 320. As used herein, the term “module” may refer to any component or set of components that perform the functionality attributed to the module. This may include one or more physical processors during execution of processor readable instructions, the processor readable instructions, circuitry, hardware, storage media, or any other components. The processor readable instructions may be stored on non-transitory computer readable storage media of the computing devices.

Assets 322, such as refrigerated trailers and/or other refrigerated transport containers, may include sensors 324, particularly temperature sensors, communications hardware for communicating with the server and transmitting the sensor readings, and tracking hardware 328, such as a GPS device, for tracking the geographic position of the asset. Sensors 324 may also include accelerometers, door open/close sensors, etc. Communications hardware 326 may include a cellular or satellite transmitter/receiver, and/or local communication transceiver such as Bluetooth, for communication between in-cab (or otherwise local) and in-container hardware, for example between in-container temperature sensors and an in-cab smartphone or dedicated device.

As noted, in certain implementations, a given client computing platform 304 may include one or more computer program modules that are the same as or similar to the computer program modules of the server(s) 302. The given client computing platform 304 may include one or more processors that are the same or similar to processor(s) 320 of the server(s) 302 to execute such computer program modules of the given client computing platform 304. Although shown as located on server 302, some modules may be distributed across two or more device (e.g. server 302 and client computing platform(s) 304) or located entirely on client computing platform(s) 304.

It should be appreciated that although modules 306, 308, 310, 312, 314, and 316 are illustrated in FIG. 13 as being co-located within a single processing unit, in implementations in which processor(s) 320 includes multiple processing units, one or more of modules 306, 308, 310, 312, 314, and/or 316 may be located remotely from the other modules. The description of the functionality provided by the different modules 306, 308, 310, 312, 314, and/or 316 described below is for illustrative purposes, and is not intended to be limiting, as any of modules 306, 308, 310, 312, 314, and/or 316 may provide more or less functionality than is described. For example, one or more of modules 306, 308, 310, 312, 314, and/or 316 may be eliminated, and some or all of its functionality may be provided by other ones of modules 306, 308, 310, 312, 314, and/or 316. As another example, processor(s) 320 may be configured to execute one or more additional modules that may perform some or all of the functionality attributed below to one of modules 306, 308, 310, 312, 314, and/or 316.

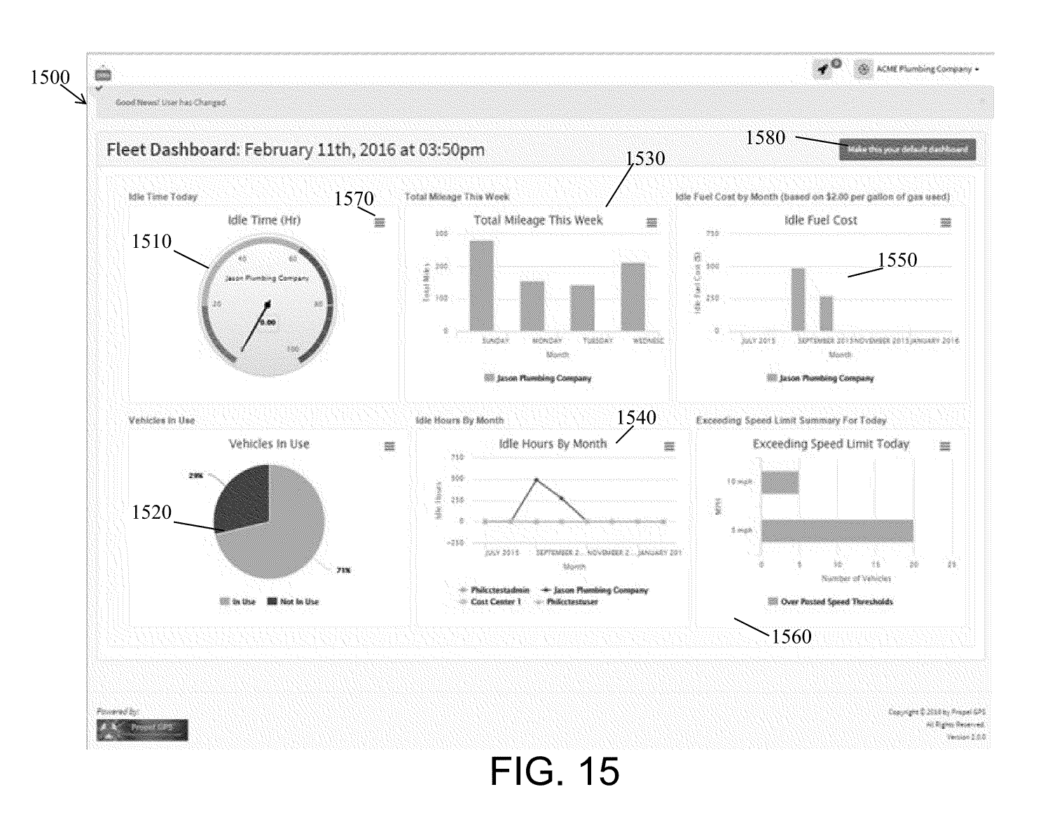

FIG. 15 is a screen shot showing a Fleet Dashboard 1500, in an embodiment of a tracking software. On this dashboard is an idle time chart 1510 showing hours of idle time for the fleet today, in use pie chart 1520 showing the percentage of fleet vehicles in use versus not in use today, total mileage bar chart 1530 showing total fleet mileage by day, idle hour line chart 1540 showing idle hours per month broken down by fleet, idle fuel cost bar chart 1550 showing monthly fuel cost due to idling, and speed limit exceeder bar chart 1560 showing number of fleet vehicles traveling 5 mph and 15 mph over posted speed limits today. Each chart 1510-1560 has an associated settings icon 1570 from which chart parameters can be changed, allowing the user to change the way the data is displayed such as the form of the chart (pie chart, bar chart, etc.), type of data displayed, time period covered, etc. The dashboard is user-configurable so that the user an see at a glance the information most important to that particular user. Once the user has set the dashboard to show the desired information in the desired format, default dashboard selector 1580 can be selected to make the fleet dashboard with those settings show up for the user from then on. The settings can still be tweaked in the future if the user wants to view other information/formats for any reason.

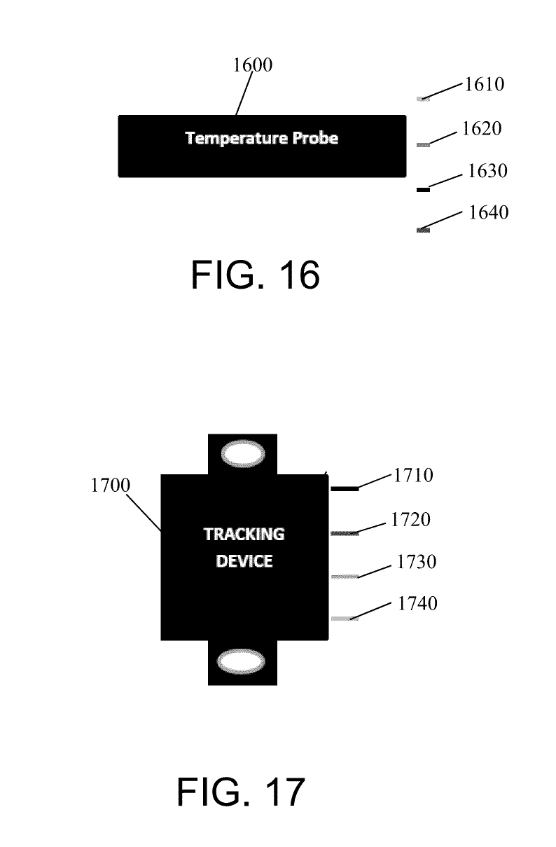

FIG. 16 illustrates a temperature probe 1600, in accordance with an embodiment of the present invention. White wire 1610 connects to the white/blue wire 1740 on tracking device 1700 (FIG. 17), blue wire 1620 connects to ground or to a previous sensor where there are multiple sensors, black wire 1630 connects to a chassis ground, red wire 1640 connects to the next sensor where there are multiple sensors, otherwise it is not used.

FIG. 17 illustrates a tracking device 1700, in accordance with an embodiment of the present invention. Black wire 1710 connects to a chassis ground, red wire 1720 connects to a constant 12V power source (always hot), white wire 1730 connects to a 12V switched power source (hot only when asset is operating), and white/blue wire 1740 connects to the white wire 1610 on temperature probe 1600 (FIG. 16).

Temperature probe 1600 and tracking device 1700 make up a suite of hardware (device) and temperature probe (sensor) mounted and installed on an asset, such as a private vehicle, commercial vehicle, generator or heavy machinery, etc. that sends the raw temperature readings via a wireless network or satellite network, such as the GSM network used by AT&T and T-Mobile in the United States or the GlobalStar satellite network available on most continents and oceans, to a (GUI) tracking software and back-end platform. The software and back-end platform allows the end user to better manage and monitor the temperature of a moving trailer or storage container connected to a vehicle or asset by accessing a web-site 24×7, smart phone mobile application, and/or by receiving reports and alerts from the Propel platform via email and/or text message on a personal cell phone. The solution bi-directionally links the data from the hardware and temperature probe mounted on the asset to the tracking software and back-end platform. The information and temperature data can be used to improve efficiencies in a business and provide real time notification when a predetermined temperature threshold has been breached. Further, the solution allows a user to better manage business decisions and alert or protect an owner from a loss of goods directly related to temperature regulations.

In embodiments, other sensors may be used instead of or in combination with one or more temperature sensors to provide additional functionality for various applications.

Embodiments described herein can be implemented in the form of control logic in software or hardware or a combination of both. The control logic may be stored in an information storage medium, such as a computer-readable medium, as a plurality of instructions adapted to direct an information processing device to perform a set of steps disclosed in the various embodiments. Software programming or code can be stored in a computer-readable medium and can be operated on by a processor to permit a computer to perform any of the steps, operations, methods, routines or portions thereof described herein. Various steps and functions of embodiments herein may be described as being carried out by specialized modules. It will be understood for purposes of this disclosure that a module is one or more computer processes, computing devices or both, configured to perform one or more functions. A module may present one or more interfaces which can be utilized to access these functions. Such interfaces include APIs, web services interfaces presented for a web services, remote procedure calls, remote method invocation, etc. The term ‘module’ may refer to one or more physical processors during execution of processor readable instructions, the processor readable instructions, circuitry, hardware, storage media, or any other components.

These and other objectives and features of the invention are apparent in the disclosure, which includes the above and ongoing written specification.

The invention is not limited to the particular embodiments described above in detail. Those skilled in the art will recognize that other arrangements could be devised. While the invention has been described with reference to specific illustrative embodiments, modifications and variations of the invention may be constructed without departing from the scope of the invention.

I claim:

1. A system, comprising:
one or more sensors installed on an asset to be tracked, wherein the sensors comprise a positioning sensor and a second sensor;
a remote central computing device configured to receive data from the sensors, process the data, associate it with a date/time of generation, and store the data in a database and comprising modules, including:
a communications module configured to receive requests for data from remote user computing devices and to transmit requested data to the remote user computing devices;
a display module configured to display the requested data on the remote user computing device, including displaying data from the positioning sensor overlaid on a map to indicate a position of the asset;
an asset information module configured to receive asset information from the remote user computing device and associate it with the asset;
a sensor reading anomaly module configured to receive sensor reading anomaly criteria from the sensor reading anomaly criteria customization module and sensor readings from the second sensor and send a notification when the sensor readings indicate that the asset crosses a sensor reading threshold;
a sensor reading anomaly criteria customization module configured to receive information relating to allowable sensor readings from the remote user computing devices and to create sensor reading anomaly criteria comprising sensor reading limits and to transmit them to the sensor anomaly module; and
a dashboard module configured to display a time-period data summary on the remote user computing device detailing information associated with the asset position over a set period of time and to display a route summary on the remote user computing device detailing compliance with the sensor reading thresholds over the time period.

2. The system of claim 1, wherein the asset information includes graphics for display on the map as part displaying the data from the positioning sensor.

3. The system of claim 1, wherein the second sensor is a temperature sensor.

4. The system of claim 1, wherein the sensor reading anomaly criteria comprise multiple tiered thresholds, wherein crossing a lower tier threshold triggers anomaly logging, crossing a higher tier threshold triggers notifications to one or more recipients, and crossing a highest tier threshold triggers notifications to multiple recipients and instructions for one or more of the recipients to take predetermined actions.

5. The system of claim 4, wherein the second sensor is a temperature sensor, wherein the lower tier threshold comprises a first temperature reading, the higher tier threshold comprises a second temperature reading higher than the first temperature reading, and the highest tier threshold comprises a third temperature reading higher than the second temperature reading, wherein the instructions comprise instructions for a driver to inspect and/or discard goods being shipped on the asset.

6. The system of claim 5, wherein at least one of the multiple tiered thresholds further comprises a time duration, such that the threshold is not considered to have been crossed unless an associated temperature reading is exceeded for at least the time duration.

7. The system of claim 6, wherein the received sensor reading anomaly criteria are functions of a type of the asset to be tracked and/or a type of load to be transported on the asset.

8. The system of claim 5, wherein the one or more sensors further comprise additional temperature sensors, wherein the temperature sensor and additional temperature sensors are installed at different locations on the asset and the installation locations are recorded, wherein one or more locations where temperature-sensitive goods are located on the asset are recorded, at least one of which is not an installation location for one of the temperature sensors, wherein the thresholds relate to determined temperature at the locations of the temperature-sensitive goods, wherein the sensor reading anomaly module is further configured to interpolate temperature readings at the locations of the temperature-sensitive goods based on sensor readings from the temperature sensors and the recorded locations of the temperature sensors and the temperature-sensitive goods.

9. The system of claim 1, wherein the sensor reading anomaly module is further configured to determine a cause of sensor reading anomalies by determining whether various factors are correlated with detected sensor reading anomalies, the various factors including environmental conditions at the position of the asset, persons controlling the asset, other sensor readings on the asset, asset type, and/or asset equipment type and/or status, when the detected sensor reading anomalies occurred.

10. The system of claim 1, wherein the sensor reading anomaly criteria customization module is further configured to record the information relating to allowable sensor readings as a template associated with an asset type and/or asset contents, and to automatically use the stored template to automatically create sensor reading anomaly criteria for other assets of the same asset type and/or having the same asset contents without further user input.

11. A method, comprising:
installing one or more sensors on an asset to be tracked, wherein the sensors comprise a positioning sensor and a second sensor;
transmitting data wirelessly from the sensors to a remote central computing device;
processing the data, associating it with a date/time of generation, and storing the data in a database;
receiving a request for some of the data from a remote user computing device;
transmitting the requested data to the remote user computing device;
displaying the requested data on the remote user computing device, including displaying data from the positioning sensor overlaid on a map to indicate a position of the asset;
receiving asset information from the remote user computing device and associating it with the asset;
receiving sensor reading anomaly criteria and sending a notification when the data indicates that asset sensor readings cross a sensor reading threshold;
receiving information relating to allowable sensor readings from the remote user computing device to create sensor reading anomaly criteria comprising sensor reading thresholds;
displaying a time-period data summary on the remote user computing device detailing information associated with the asset location over a set period of time; and
displaying a route summary on the remote user computing device detailing compliance with the sensor reading limits over the time period.

12. The method of claim 11, wherein the asset information includes graphics for display on the map as part displaying the data from the positioning sensor.

13. The method of claim 11, wherein the second sensor is a temperature sensor.

14. The method of claim 11, wherein the sensor reading anomaly criteria comprise multiple tiered thresholds, wherein crossing a lower tier threshold triggers anomaly logging, crossing a higher tier threshold triggers notifications to one or more recipients, and crossing a highest tier threshold triggers notifications to multiple recipients and instructions for one or more of the recipients to take predetermined actions.

15. The method of claim 14, wherein the second sensor is a temperature sensor, wherein the lower tier threshold comprises a first temperature reading, the higher tier threshold comprises a second temperature reading higher than the first temperature reading, and the highest tier threshold comprises a third temperature reading higher than the second temperature reading, wherein the instructions comprise instructions for a driver to inspect and/or discard goods being shipped on the asset.

16. The method of claim 15, wherein at least one of the multiple tiered thresholds further comprises a time duration, such that the threshold is not considered to have been crossed unless an associated temperature reading is exceeded for at least the time duration.

17. The method of claim 16, wherein the received sensor reading anomaly criteria are functions of a type of the asset to be tracked and/or a type of load to be transported on the asset.

18. The method of claim 15, wherein the one or more sensors further comprise additional temperature sensors, wherein the temperature sensor and additional temperature sensors are installed at different locations on the asset and the installation locations are recorded, wherein one or more locations where temperature-sensitive goods are located on the asset are recorded, at least one of which is not an installation location for one of the temperature sensors, wherein the thresholds relate to determined temperature at the locations of the temperature-sensitive goods, further comprising interpolating temperature readings at the locations of the temperature-sensitive goods based on sensor readings from the temperature sensors and the recorded locations of the temperature sensors and the temperature-sensitive goods.

19. The method of claim 11, further comprising determining a cause of sensor reading anomalies by determining whether various factors are correlated with detected sensor reading anomalies, the various factors including environmental conditions at the position of the asset, persons controlling the asset, other sensor readings on the asset, asset type, and/or asset equipment type and/or status, when the detected sensor reading anomalies occurred.

20. The method of claim 11, further comprising recording the information relating to allowable sensor readings as a template associated with an asset type and/or asset contents, and automatically using the stored template to automatically create sensor reading anomaly criteria for other assets of the same asset type and/or having the same asset contents without further user input.
